(19) United States
(12) Patent Application Publication
(10) Pub. No.: US 2006/0202456 A1
(43) Pub. Date: Sep. 14, 2006

(54) Curtain airbag with deflation mechanism

(75) Inventor: Albert R. Bernat, Rochester Hills, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/075,823

(22) Filed: Mar. 9, 2005

(51) Int. Cl. B60R 21/239

(52) U.S. Cl. 280/739; 280/743.1; 280/730.2

(57) ABSTRACT

A curtain airbag configured to remain inflated in order to protect a vehicle occupant from a rollover event. The airbag includes a deflation mechanism configured to permit rescue personnel responding to the rollover event to deflate the airbag without the use of tools.

### BACKGROUND

The present invention relates to a protective airbag for protection of a vehicle occupant and, more particularly, to an airbag which is to be inflated to expand all the interior side of the vehicle cabin in the event of a lateral collision or roll-over of a vehicle and then to deflate.

In general, airbags are employed in vehicles as secondary restraint mechanisms to operate in conjunction with seat belts in order to provide protection for the vehicle occupant during an impact event. There are several different types of airbags that are currently employed in vehicles. For example, front impact airbags are used typically in the steering wheel and in the dashboard in front of the passenger side front seat of a vehicle. The front impact airbags are designed to inflate quickly and to deflate as an occupant impacts the inflated airbag. Another type of airbag typically found in vehicles is a curtain type side airbag for protecting the vehicle occupants in the case of a lateral impact or rollover situation. The curtain airbag is typically stored along the roofline at the side of the vehicle cabin and deploys downwardly when inflated to cover the vehicle's side windows and pillars.

Japanese Unexamined Patent Publication No. H10-291457 (incorporated by reference herein) discloses an exemplary airbag. The disclosed airbag comprises two sheets which are superposed on each other and joined together along their peripheral edges to form chambers (cells), extending vertically.

The upper portions of the chambers are in fluid communication with an upper chamber extending along the upper edge of the airbag. Formed in the sheet is an opening for allowing gas to be supplied into the upper chamber. Portions between adjacent chambers are defined as webs into which no gas is permitted to be introduced.

The airbag is folded by pulling the lower edge thereof up and is disposed along about a roof side rail, i.e., a corner formed by a roof and a side portion of a vehicle, an A-pillar, and a C-pillar. The airbag is covered by a suitable cover such as a pillar trim and a roof trim.

The airbag having the aforementioned structure acts as follows. When the vehicle is involved in a lateral collision or roll-over, gas is supplied into the upper chamber through the opening. The gas inflates the upper chamber and the vertical chambers, whereby the airbag pushes and opens the cover and expands over the windows of the side doors. The airbag lies between the occupant's head and the side portion of the vehicle, thereby protecting the occupant's head.

When the window is opened or broken, the occupant's body is protected from being thrown out of the vehicle by the airbag, which remains inflated in order to protect the occupant during a rollover situation. However, in certain situations, the airbag may remain inflated too long, preventing the occupant from escaping from the vehicle or from being attended to by rescue personnel. Thus, there remains a need for a mechanism that may be activated to deflate a deployed curtain type airbag in order to permit a vehicle occupant to escape the vehicle or be rescued.

### SUMMARY

It is an object of the present invention to provide a curtain airbag having a mechanism for deflating of the airbag.

An airbag of the present invention is a curtain airbag to be disposed to extend along at least one pillar and a roof side rail and including a chamber for retaining inflation gas gas. An inflator provides inflation gas to the chamber. The airbag may be formed from material such as, for example, impermeable or semi-impermeable material, so that the inflation gas is retained in the chamber and the airbag inflates. As the airbag inflates it unfolds deploying along the side of the vehicle interior.

According to an embodiment of the present invention, the airbag includes a deflation mechanism. The deflation mechanism provides for an escape path to allow inflation gas to exit the chamber, thus deflating the airbag. In one exemplary embodiment, a failure mechanism is provided as the mechanism for deflation, wherein a portion of the airbag fails, breaching the integrity of the airbag chamber and allowing gas to flow out of the airbag chamber. In another exemplary embodiment, a vent is provided in the chamber to allow gas to escape the chamber when the vent is open. In another embodiment, a valve is provided as the deflation mechanism to controllably release gas from the airbag chamber. According to yet another embodiment, a zipper is provided so that opening the zipper permits the inflation gas to escape.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view, as seen from a vehicle cabin, showing a curtain airbag.

FIG. 2 is a side view of a curtain airbag.

FIG. 3 is an illustration of one embodiment of the present invention wherein a low strength seam is used as the deflation mechanism.

FIG. 4 is an illustration of one exemplary embodiment of the present invention utilizing a vent with a pressure release cover.

FIG. 5 illustrates an embodiment of the present invention having a gas permeable portion of the airbag covered with a gas impermeable layer attached to an opposing portion of the airbag.

FIG. 6 illustrates an embodiment of the present invention wherein the deflation mechanism is a circular disk valve having flexible valve elements.

FIG. 7 illustrates the flexible valve elements in a flexed position, with the valve open.

FIG. 8 illustrates another embodiment of a deflation mechanism according to the present invention

### DETAILED DESCRIPTION

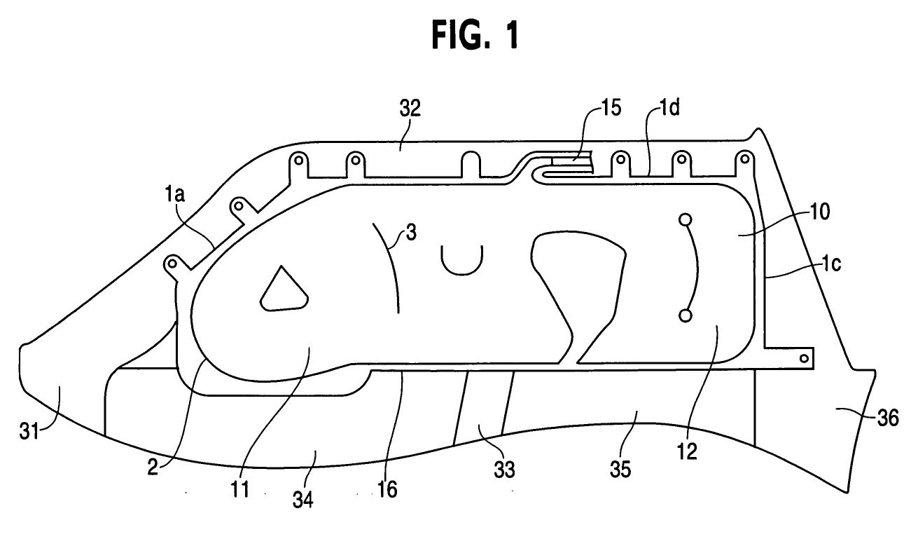

FIG. 1 is a front view, as seen from a vehicle cabin, showing a curtain airbag according to an embodiment of the present invention. In the following description, the longitudinal direction is the longitudinal (front-and-back) direction of a vehicle to which the curtain airbag is installed.

A curtain airbag (hereinafter, sometimes simply called “airbag”) 10 of this embodiment of the invention is folded and disposed to extend from an A-pillar 31 over a B-pillar 33 to a C-pillar 36 through a roof side rail 32 of a vehicle 30. The airbag 10 in an exemplary embodiment has substantially a trapezoidal profile in the deployment state so that it is inflated into a curtain shape to extend along a side surface of the vehicle cabin from the roof side rail 32 and the respective pillars 31, 33, 36 to the vicinity of the upper edges of front and rear door panels 34, 35 so as to cover over the upper half of a side face of the vehicle cabin in the event of a lateral collision or roll-over of a vehicle.

The airbag 10 has a front side 1a extending along the A-pillar 31, a lower side 1b extending along the upper edges of the door panels 34, 35, a rear side 1c extending along the B-pillar 33, and an upper side 1d extending along the roof side rail 32 wherein the lower side 1b is longer than the upper edge 1d so that the airbag 10 substantially has a trapezoidal profile.

The airbag 10 comprises two sheets which are joined to each other by joints including a line-shaped joint 2 extending around their peripheries (with some parts thereof extending inward of the sheets), line-shaped joints 3 extending inside the peripheries, and circular joints 8 for reinforcing areas around ends of the line-shaped joints. The airbag 10 is designed to be inflated by introduction of gas into spaces between the sheets. It should be noted that the line-shaped joints and the circular joints may be formed by any of various joining means such as sewing, bonding, and welding.

The airbag 10 may include an L-shaped projection 15 extending from a middle portion in the longitudinal direction of the upper side 1d thereof. Formed in the projection 15 is a gas inlet for introducing gas into the airbag 10. A gas generator (inflator) is connected to the gas inlet for inflating the airbag 10. In an alternative embodiment, the projection 15 may be a separate piece from the airbag 10.

The airbag 10 may be folded by pulling the lower edge thereof up and is disposed along about the roof side rail 32, the A-pillar 31, and the C-pillar 36. In a storage position, the airbag 10 is covered by a suitable cover such as a pillar trim and a roof trim (not shown).

The airbag 10 having the aforementioned structure acts as follows. When the vehicle is involved in a lateral collision or roll-over, the inflator is activated to supply gas into the airbag 10. The gas from the inflator flows through the gas inlet 15 so as to inflate the airbag 10 downwardly. Then, the airbag 10 pushes open the roof trim above the vehicle pillars and thus starts to deploy into the vehicle cabin. As shown in FIG. 1, the fully deployed airbag covers the side of the vehicle to protect the vehicle occupants.

The above embodiment is merely an illustrative examples of the present invention and the present invention is not limited to the above embodiment.

Though the circular joints are provided at ends of the line-shaped joints for reinforcing areas around ends of the line-shaped joints defining the first and second cells and the first and second gas passages, the circular joints may be omitted by connecting an end of a line-shaped joint midway to another line-shaped joint, and by connecting ends of line-shaped joints.

Though a first gas passage is disposed substantially at the middle in the longitudinal direction of the airbag in the above embodiments, the location of the first gas passage is not limited thereto. Further, two first gas passages may be provided to be disposed at different locations in the longitudinal direction of the airbag. In this case, it is preferable that the airbag is provided along the upper side of the airbag with a gas distributing means such as a duct having gas ports which are in communication with upper parts of the respective first gas passages.

Though the gas inlet is disposed substantially at the middle in the longitudinal direction of the upper side of the airbag in the above embodiments, the location of the gas inlet is not limited thereto. The inflator to be connected to the gas inlet may be located at any place such as the roof side rail or the C-pillar of the vehicle. When the inflator is located in the C-pillar, a duct for introduction of gas may be connected to the inflator in order to introduce gas from the inflator into the first gas passage.

Though the curtain airbag is fabricated by joining two sheets together in the above embodiments, the fabrication of the airbag is not limited thereto. For example, the airbag may be obtained by using a base fabric which is woven originally into an envelope shape by a so-called “hollow weaving” or “jacquard weaving” method. In this case, the first and second cells and the first and second gas passages are formed inside the airbag by woven joints inside and along the periphery of the airbag, instead of joining the opposite surfaces of the airbag by the line-shaped joints to divide the inside of the airbag.

The airbag may be formed by coated fabric in order to provide improved permeability characteristics. Curtain airbags are typically configured to provide protection for a rollover event and, therefore, remain inflated for a substantial period of time. Front impact airbags, on the other hand, typically remain inflated for less than a second.

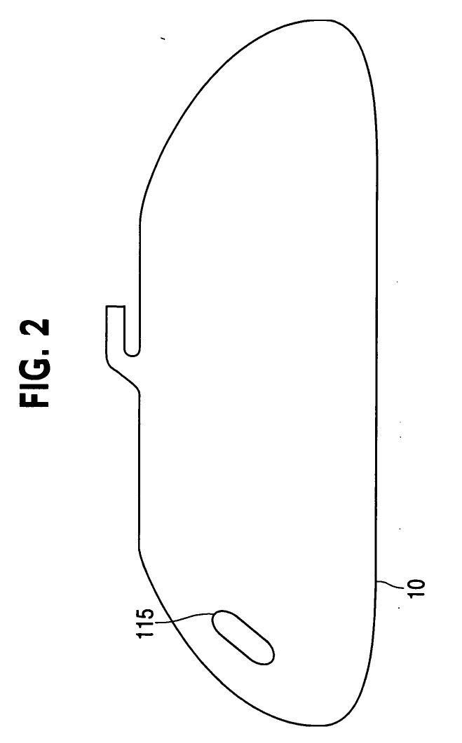

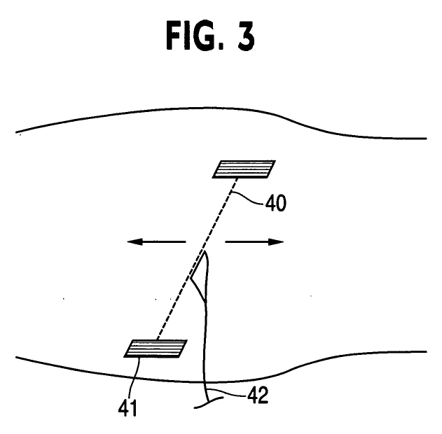

The curtain airbag may also include a deflation mechanism. The deflation mechanism of the present invention may be any of the various mechanisms understood by one skilled in the art to be within the scope and concepts of the present invention. In one exemplary embodiment, as shown in FIG. 2, the deflation mechanism 15 comprises a failure mechanism designed to cause the integrity of the airbag chamber to fail, i.e. such as by tearing, ripping, or bursting. For example, in one embodiment shown in FIG. 3, the failure mechanism comprises a relatively low strength seam 40 which is designed to fail when the an excessive separation force is applied to the seam. Such as, for example, force applied in the direction of the arrows shown in FIG. 3.

According to one embodiment of the present invention, the seam 40 may be separated by pulling on a tab and cord arrangement 42 in order to apply a breaking force on one side of the seam. The seam 40 and tab and cord arrangement 42 may be positioned on either the interior or exterior side of the airbag (or both) so that the seam may be separated by either rescue personnel or a vehicle occupant. Alternatively, the seam can be configured to separate when the pressure in the chamber reaches a predetermined value.

In the disclosed embodiments, the cord is shown for exemplary purposes only. The scope of the present invention includes any suitable grasping device that would permit deflation of the airbag without the use of additional tools or cutting device.

Reinforcing patches or seams 41 may be provided in order to prevent complete failure of the chamber wall and to ensure controlled deflation of the airbag. Controlling deflation may be important in certain rescue situations where limiting movement and stabilization of the occupant is critical.

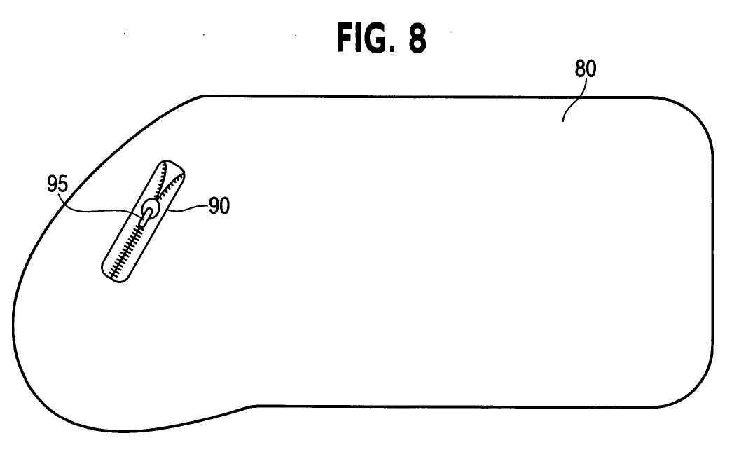

According to another embodiment of the present invention, a zipper 90 may be provided instead of a seam 40. The zipper is positioned in one of the walls of the chamber and in order to deflate the airbag, the zipper is simply opened to allow gas to escape from the inflation chamber. The pull tab 95 for the zipper may be positioned on either the interior side or exterior side of the airbag (or both). FIG. 8 discloses an exemplary view of a zipper positioned in an airbag 80. The zipper may be sealed with a supplemental material (e.g., silicone or the like) during fabrication of the airbag to ensure that no leakage occurs during airbag inflation.

In another exemplary embodiment of the present invention, the deflation mechanism may include a vent. The vent may include an aperture that places the interior of the airbag chamber in fluid communication with the outside of the airbag chamber thereby allowing the inflation gas to escape from the interior of the airbag chamber. The vent may be located at any location on the airbag which would not interfere with the airbag's operation and preferably in a location that will minimize impact on a vehicle occupant during deployment and on the storage of the airbag prior to deployment.

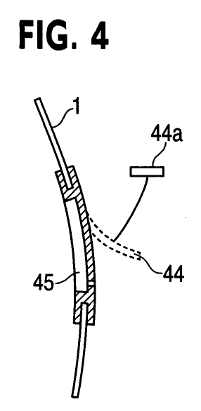

The venting mechanism, as shown in FIG. 4, may include a cover 44. The cover 44 is removably attached to the airbag 10 and covers a vent opening 45. The cover 44 is attached to the airbag 10, and is configured to become at least partially detached to allow air from the airbag chamber to escape, thus facilitating at least partially deflating the airbag. The cover 44 may include a cord 44a that may be grasped to allow rescue personnel or vehicle occupants to uncover the vent opening 45. As mentioned above, the cover 44 and cord 44a may be positioned on either the interior or exterior side of the airbag (or both) so that the vent cover may be easily removed by either rescue personnel or a vehicle occupant.

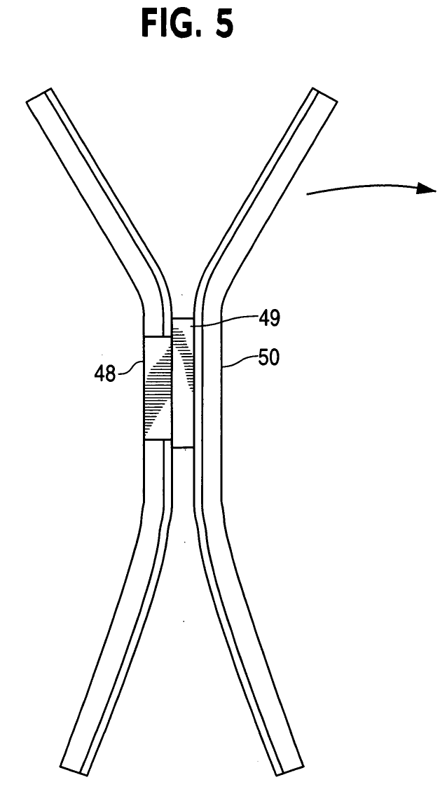

According to yet another exemplary embodiment of the present invention, shown in FIG. 5, the deflation mechanism may include a gas permeable section 48 of the airbag fabric. The gas permeable section 48 of the airbag is sealed with a gas impermeable layer 49 which is affixed to another portion of the airbag 50, for example, in one embodiment, the impermeable layer 49 is affixed to a portion of the airbag located opposite the gas permeable section when the airbag is inflated. When deflation of the airbag is desired, the the gas permeable layer 48 may be separated from the impermeable layer 49 and other fabric layer 50 to provide a vent path through the permeable fabric portion.

Separation of the airbag material may be accomplished by pulling the airbag fabric 50 in the direction indicated by the arrow in FIG. 5. Alternatively, a cord or pull tab may also be provided. As mentioned above, the permeable portion of the airbag may be positioned on either the interior or exterior side of the airbag (or both) so that the deflation of the airbag may be easily initiated by either rescue personnel (located outside the vehicle) or a vehicle occupant (located inside the vehicle).

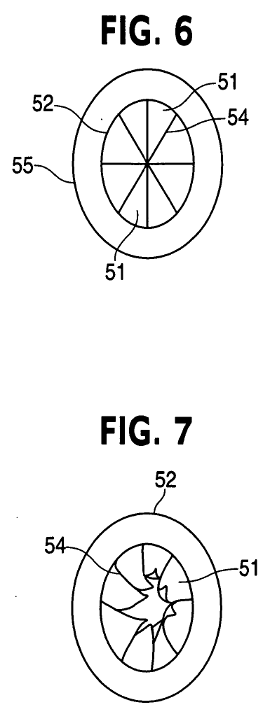

In another exemplary embodiment, the deflation mechanism includes a valve. The valve may be any of a number of designs in the art to allow the release of gas from the airbag chamber. For example, in one embodiment shown in FIGS. 6 and 7, a circular disk valve 55 may be used. The circular disk valve 55 has flexible valve elements 51 which extend inwardly from an outer circumference 52 of the disk valve 50 and engaging the adjacent flexible valve element 51 along a sealed boundary 54 when the valve is closed. As shown in FIG. 7 when the airbag 10 is inflated, the valve elements 51 separate along the boundaries 54 and may be initially flexed inwardly to open the valve 55. Of course, after gas begins to escape through the valve 55, the valve elements may flex outwardly due to the flow of escaping gas.

Opening of the valve may be accomplished by a blow to the valve elements with a hand or readily available element, such as a pen or the like. The airbag may be labeled with basic instructions explaining the valve opening process to vehicle occupants or rescue personnel. Also, the valve may be positioned on either the interior or exterior side of the airbag (or both) so that the deflation of the airbag may be easily initiated by either rescue personnel (located outside the vehicle) or a vehicle occupant (located inside the vehicle).

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A side curtain airbag for a vehicle, comprising:
an airbag chamber including a chamber and a passage for carrying inflation gas from an inflator to the chamber; and
a deflation mechanism located along the boundary of the chamber;
wherein the mechanism is configured to be activated by rescue personnel in order to deflate the airbag and allow improved access to the interior of the vehicle.

2. The curtain airbag of claim 1, wherein the deflation mechanism comprises a relatively low strength seam.

3. The curtain airbag of claim 2, wherein the deflation mechanism comprises a cord for facilitating tearing of the seam.

4. The curtain airbag of claim 1, wherein the airbag includes coated fabric forming the chamber and the deflation mechanism includes a covered opening in the coated fabric.

5. The curtain airbag device of claim 4, further comprising a device configured to be pulled to detach a cover from the fabric to thereby uncover the opening and allow inflation gas to escape the chamber.

6. The curtain airbag of claim 1, wherein the airbag includes fabric forming the chamber and wherein the fabric includes a covered gas permeable section.

7. The curtain airbag of claim 6, wherein the gas permeable section is covered by a removable piece of coated fabric.

8. The curtain airbag of claim 7, wherein the coated fabric is configured with a grasping device to allow the coated fabric to be pulled away from the permeable section and thereby allow inflation gas to escape the chamber.

9. The curtain airbag of claim 1, wherein the deflation mechanism is a valve located in a wall of the chamber.

10. The curtain airbag of claim 9, wherein the valve includes a rupturable valve disk configured to be ruptured by rescue personnel in order to deflate the airbag.

11. The curtain airbag of claim 9, wherein the valve includes a disk valve having a plurality of connected flexible valve elements which are configured to separate in order to allow inflation gas to escape from the chamber.

12. An airbag configured to deploy along an interior side of a vehicle comprising:
at least one inflatable cell adapted to remain inflated for at least 5 seconds after an impact event;
a vent located in a wall of the cell to thereby provide a passage for gas to vent from the inflatable cell; and
a deflation mechanism configured to allow a vehicle occupant or a rescue worker to control the deflation of the cell.

13. The airbag of claim 12, wherein the deflation mechanism comprises a low strength seam configured to be broken when a predetermined breaking pressure is applied.

14. The curtain airbag of claim 13, wherein the deflation mechanism comprises a cord for facilitating tearing of the seam.

15. The curtain airbag of claim 12, wherein the airbag includes coated fabric forming the cell and the deflation mechanism includes a covered opening in the coated fabric.

16. The curtain airbag device of claim 15, further comprising a device configured to be pulled to detach a cover from the fabric to thereby uncover the opening and allow inflation gas to escape the chamber.

17. The curtain airbag of claim 12, wherein the deflation mechanism comprises a zipper.

18. The curtain airbag of claim 1, wherein the deflation mechanism is a valve located in a wall of the chamber.

19. The curtain airbag of claim 18, wherein the valve includes a rupturable valve disk configured to be ruptured by rescue personnel in order to deflate the airbag.

20. A curtain airbag configured to remain inflated in order to protect a vehicle occupant from a rollover event, wherein the airbag includes a deflation mechanism configured to permit rescue personnel responding to the rollover event to deflate the airbag without the use of tools.
